(19) United States
(12) Patent Application Publication
(10) Pub. No.: US 2007/0300279 A1
(43) Pub. Date: Dec. 27, 2007

(54) Method of providing integrated file list and video apparatus using the same

(75) Inventors: Dae-gu Kim, Suwon-si (KR); Jin-ho Yim, Suwon-si (KR); Sang-hee Lee, Seoul (KR); Dong-heon Lee, Seoul (KR); Won-il Kim, Chungju-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/655,247

(22) Filed: Jan. 19, 2007

(30) Foreign Application Priority Data
Jun. 21, 2006 (KR) 10-2006-0055969

(51) Int. Cl. G06F 17/00; G06F 15/00; H04N 7/16; H04N 7/173

(52) U.S. Cl. 725/132; 725/135; 715/500.1; 715/501.1

(57) ABSTRACT

A method of providing an integrated file list and a video appliance using the same are provided. The video appliance includes a combining unit for combining a video signal to be displayed with desired information, and a control unit for creating an integrated file list enumerated with files stored in a plurality of recording media, and controlling the combining unit to combine the video signal to be displayed with the created integrated file list. According to the video appliance, a user can effectively manage the files dispersedly stored in several recording media.

### CROSS-REFERENCE TO RELATED APPLICATIONS

This application is based on and claims priority from Korean Patent Application No. 10-2006-0055969, filed Jun. 21, 2006 in the Korean Intellectual Property Office, the entire contents of which is incorporated herein by reference.

### BACKGROUND OF THE INVENTION

1. Field of the Invention

Apparatuses and methods consistent with the present invention relate to providing an integrated file list. More particularly, the present invention relates to a method of integrally providing a list of files dispersedly stored in several recording media and a video appliance using the same.

2. Description of the Related Art

Recently, a recording medium with files stored thereon is generally built in a video appliance such as a television (TV) set and a set-top box. The video appliance can reproduce the file stored in the recording medium built therein.

Further, the video appliance is connected to an external appliance to communicate with each other. The video appliance and the external appliance are communicably connected to each other, so that the video appliance can reproduce the file stored in the recording medium built in the external appliance.

The video appliance provides a file list through a display so that a user selects the file to be reproduced. The file list is generally created for each recording medium.

Since the file list is created for each recording medium, it is difficult for the user to effectively manage the files dispersedly stored in several recording media, when the number of the recording media built in the video appliance is increased or the number of the external appliances is increased.

### SUMMARY OF THE INVENTION

The present invention provides a method of integrally providing a list of files dispersedly stored in several recording media, and a video appliance using the same, whereby a user can effectively manage the files dispersedly stored in several recording media.

According to an aspect of the present invention, there is provided a video appliance which comprises a combining unit for combining a video signal to be displayed with desired information, and a control unit for creating an integrated file list enumerated with files stored in a plurality of recording media, and controlling the combining unit to combine the video signal to be displayed with the created integrated file list.

One of the plurality of recording media may be a recording medium built in the video appliance, and another of the plurality of recording media may be a recording medium provided in an external appliance communicably connected to the video appliance.

The integrated file list may enumerate a part or all of the files stored in one of the recording media and a part or all of the files stored in another of the recording media.

The integrated file list may enumerate the files in such a manner that the files are classified and arranged according to file types of the files.

The file type may include any one of a moving image file, a still image file, and a music file.

The video appliance further comprises a processing unit for processing the file to reproduce the same. The control unit may apply a file selected by a user, which is among the files enumerated in the integrated file list, to the processing unit.

According to another aspect of the present invention, there is provided a method of providing an integrated file list which comprises creating the integrated file list enumerated with files stored in a plurality of recording media, and combining a video signal to be displayed with the created integrated file list.

One of the plurality of recording media may be a recording medium built in a video appliance, and another of the plurality of recording media may be a recording medium provided in an external appliance communicably connected to the video appliance.

The integrated file list may enumerate a part or all of the files stored in one of the recording media and a part or all of the files stored in another of the recording media.

The integrated file list may enumerate the files in such a manner that the files are classified and arranged according to file types of the files.

The file type may include any one of a moving image file, a still image file, and a music file.

### BRIEF DESCRIPTION OF THE DRAWINGS

The above and other aspects of the present invention will become more apparent by describing in detail exemplary embodiments thereof with reference to the attached drawing figures, wherein;

FIG. 1 is a block diagram illustrating the construction of a video appliance according to an exemplary embodiment of the present invention;

FIG. 2 is a view illustrating one example of a file status table;

FIG. 3 is a flowchart explaining a method of providing an integrated file list according to another exemplary embodiment of the present invention;

FIG. 4 is a view illustrating one example of the integrated file list created at operation S350 of FIG. 3, if a file status table corresponds to that shown in FIG. 2;

FIG. 5 is a block diagram of a video apparatus according to another exemplary embodiment of the present invention; and

FIG. 6 is a flowchart illustrating a method of providing an integrated file list according to another exemplary embodiment of the present invention.

Throughout the drawings, like reference numerals will be understood to refer to like parts, components and structures.

### DETAILED DESCRIPTION OF EXEMPLARY EMBODIMENTS OF THE PRESENT INVENTION

Hereinafter, exemplary embodiments of the present invention will be described in detail with reference to the accompanying drawing figures.

In the following description, the same drawing reference numerals are used for the same elements even in different drawings. The matters defined in the description such as a detailed construction and elements are provided to assist in a comprehensive understanding of the invention. Thus, it is apparent that exemplary embodiments of the present invention can be carried out without those defined matters. Also, well-known functions or constructions are not described in detail since they would obscure the invention in unnecessary detail.

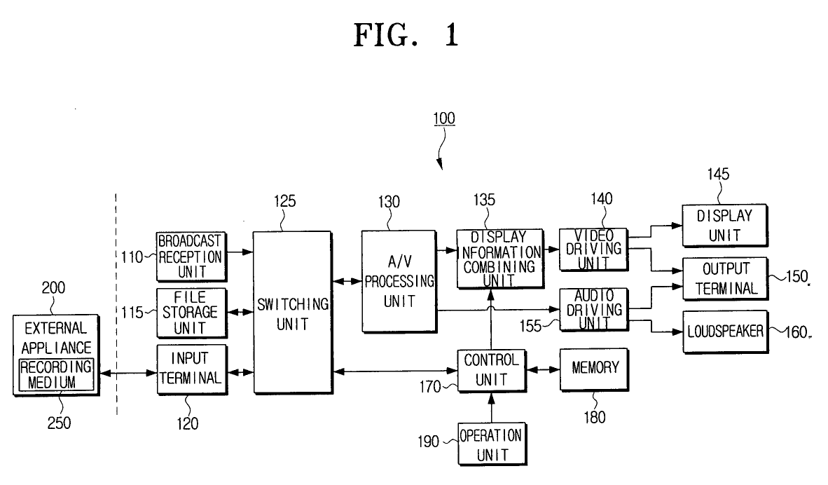

FIG. 1 is a block diagram illustrating the construction of a video appliance according to an exemplary embodiment of the present invention. The video appliance according to this exemplary embodiment provides an integrated file list on a display so that a user selects a desired file. The term “integrated file list” means one list enumerating files dispersedly stored in several recording media.

Referring to FIG. 1, a video appliance 100 is communicably connected to an external appliance 200 with a recording medium 250 built therein. The video appliance 100 includes a broadcast reception unit 110, a file storage unit 115, an input terminal 120, a switching unit 125, an audio/video (A/V) processing unit 130, a display information combining unit 135, a video driving unit 140, a display unit 145, an output terminal 150, an audio driving unit 155, a loudspeaker 160, a control unit 170, a memory 180, and an operation unit 190.

The broadcast reception unit 110 tunes and demodulates a TV broadcast signal. The file storage unit 115 stores a file in a recording medium, or reads a file from the recording medium. The file storage unit 115 may include various recording medium as a means for storing a file. A typical example is a hard disk drive (HDD).

The input terminal 120 provides a communication interface so that the video appliance is communicably connected to the external appliance 200. The external appliance 200 connected to the input terminal 120 can include a personal computer (PC), a camera, a camcorder, a digital versatile disk (DVD) player, a portable media player (PMP), an HDD player, and a memory card. Therefore, any appliance with a recording medium recording a file may serve as a role of the external appliance 200.

The switching unit 125 performs a switching operation to transmit any one of outputs from the broadcast reception unit, the file storage unit 15, and the input terminal unit 120 to the AN processing unit 130 or the control unit 170. The switching operation of the switching unit 125 is controlled by the control unit 170.

The A/V processing unit 130 performs a signal process so that a video and/or audio signal transmitted through the switching unit 125 can be reproduced. The A/V processing unit 130 transmits the video signal to the display information combining unit 135, and the audio signal to the audio driving unit 155.

The display information combining unit 135 combines the video signal output from the A/V processing unit 130 with display information such as characters, symbols, figures, or graphics. In this instance, the display information combining unit 135 may perform the process of combining the display information in an On Screen Display (OSD) mode. The combination processing operation of the display information combining unit 135 is controlled by the control unit 170.

The video driving unit 140 displays the video combined with the display information output from the display information combining unit 135 on the display unit 145, or transmits the same to another external appliance (not shown) connected thereto via the output terminal 150.

The audio driving unit 155 outputs the audio output from the A/V processing unit 130 via the loudspeaker 160, or transmits the same to another external appliance (not shown) connected thereto via the output terminal 150.

The control unit 170 controls the operation of the video appliance 100 in response to an operation command of the user input through the operation unit 190.

In particular, the control unit 170 receives the information on the files (hereinafter referred to as “file information”), which are stored in the file storage unit 115, from the file storage unit 115 via the switching unit 125, and receives the file information of the recording medium 250 from the external appliance 200 via the input terminal 120 and the switching unit 125. Here, the term “file information” means a file type, a file name, file creating data, etc., of the stored file.

The control unit 170 creates and updates a file status table on the basis of the received file information, and stores the created/updated file status table in the memory 180.

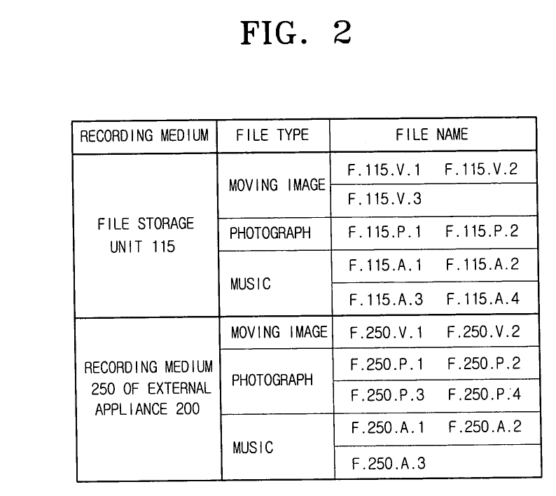

The file status table is a table composed of the file information on the files stored in the recording medium (i.e., the file storage 115) built in the video appliance 100 and the file information on the files stored in the recording medium (i.e., the recording medium 250) provided in the external appliance 200 communicably connected to the video appliance 100. FIG. 2 is a view illustrating one example of the file status table.

It will be understood from FIG. 2 that the file storage unit 115 is stored with a) moving image files “F.115.V.1”, “F.115.V.2”, and “F.115.V.3”, b) photograph files “F.115.P.1” and “F.115.P.2”, and c) music files “F.115.A.1”, “F.115.A.2”, “F.115.A.3”, and “F.115.A.4”.

Further, it will be understood that the recording medium 250 of the external appliance 200 is stored with a) moving image files “F.250.V.1” and “F.250.V.2”, b) photograph files “F.250.P.1”, “F.250.P.2”, “F.250.P.3”, and “F.250.P.4” and c) music files “F.250.A.1”, “F.250.A.2”, and “F.250.A.3”.

The control unit 170 creates the integrated file list by referring to the file status table stored in the memory 180. Further, the control unit 170 controls the display information combining unit 135 to show the created integrated file list on the display.

As described above, the integrated file list is one list enumerating files dispersedly stored in several recording media (i.e., the file storage unit 115 and the recording medium 250 of the external appliance 200). In the creation of the integrated file list, the control unit 170 may classify and enumerate the files configuring the integrated file list into the file types (e.g., a moving image file, a still image file, and a music file).

The user can select a desired file among the files enumerated in the integrated file list. In this instance, the control unit 170 controls the file storage unit 115, the external appliance 200, and the switching unit 125 so as to apply the file selected by the user to the A/V processing unit 130 and thus reproduce the file selected by the user.

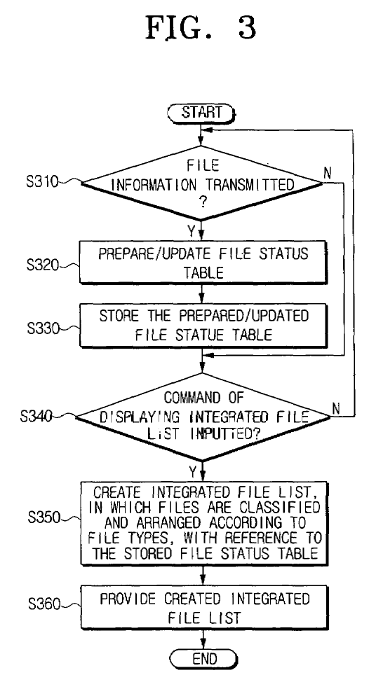

Now, a process of providing the integrated file list will be described in detail with reference to FIG. 3. FIG. 3 is a flowchart explaining a method of providing the integrated file list according to another exemplary embodiment of the present invention.

Referring to FIG. 3, when the control unit 170 receives the file information from the file storage unit 115 and/or the external appliance 200 (“Yes” in operation (S310)), the control unit 170 prepares and updates the file status table on the basis of the transmitted file information in operation (S320), and stores the prepared/updated file status table in the memory 180 in operation (S330).

Then, when a command of displaying the integrated file list is input by the user through the operation unit 190 (“Yes” in operation (S340)), the control units 170 creates the integrated file list, in which files are classified and arranged according to file types of the files, with reference to the file status table stored in the memory 180 in operation (S350). The control unit 170 controls the display information combining unit 135 to show the created file list on the display in operation (S360). As such, the integrated file list is shown on the display unit 145.

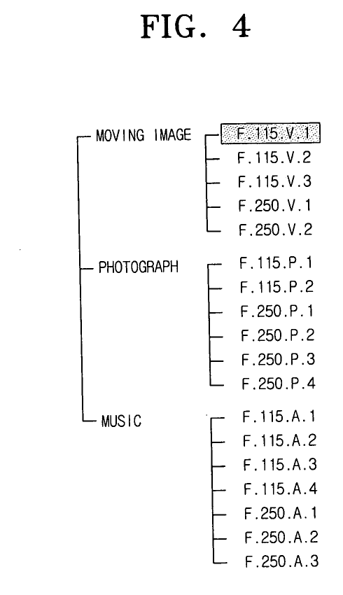

FIG. 4 is a view illustrating one example of the integrated file list created in operation S350 of FIG. 3, if a file status table corresponds to that shown in FIG. 2. It will be understood that the integrated file list enumerates the files dispersedly stored in the file storage unit 115 and the recording medium 250 of the external appliance 200. Further, in the integrated file list, the files configuring the list are classified and arranged according to the file types (i.e., a moving image file, a still image file, and a music file).

In this exemplary embodiment, the file storage unit 115 built in the video appliance 100 and the recording medium 250 of the external appliance 200 are shown and described as an example of the recording medium in which the files enumerated in the integrated file list are stored. However, it is merely one example to which an exemplary embodiment of the present invention can be applied, and thus the technical aspects of an exemplary embodiment of the present invention can be applied to a case in which an integrated file list is created by the files stored in two or more recording media built in the video appliance or an integrated file list is created by the files stored in the recording media provided in two or more external appliances.

In addition, the technical aspects of an exemplary embodiment of the present invention can be applied to a case in which an integrated file list is created by the files stored in two or more recording media built in the video appliance and the recording media provided in two or more external appliances.

Further, in this exemplary embodiment, the case in which the files dispersedly stored in several recording media are enumerated in one list is shown and described as an example of the present invention. Several integrated file lists can be created by use of the files dispersedly stored in several recording media. For example, an integrated file list enumerated with only moving image files dispersedly stored in several recording media, an integrated file list enumerated with only still image files dispersedly stored in several recording media, and an integrated file list enumerated with only music files dispersedly stored in several recording media may be created.

That is, an exemplary embodiment of the present invention can be applied to a case of creating an integrated file list enumerated with a part of the files stored in one recording medium and a part of the files stored in another recording medium.

Since the video appliance shown in FIG. 1 is an exemplary embodiment, a video appliance to which an exemplary embodiment of the present invention is applied does not necessarily include all blocks shown in FIG. 1, and any of the blocks may be omitted. For example, in a case in which a video appliance is a set-top box, the display unit 145 and the loudspeaker can be removed.

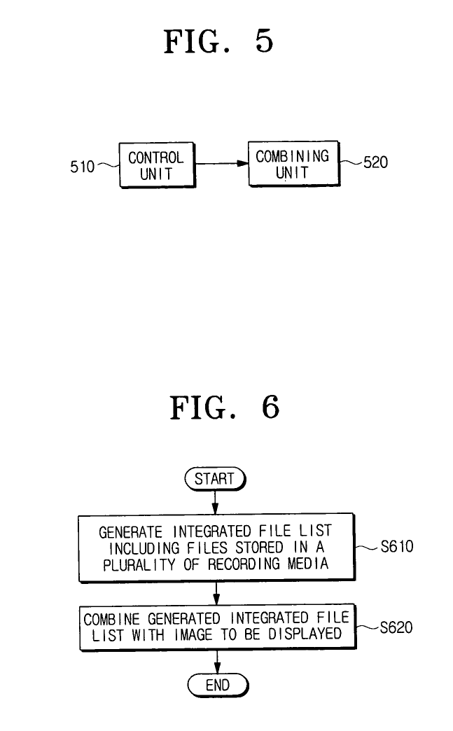

Other exemplary embodiments of the present invention will be explained below with reference to FIGS. 5 and 6.

With reference to FIG. 5, a video appliance includes a control unit 510 and a combining unit 520. The combining unit 520 combines a video signal to be displayed with desired information. The control unit 510 creates an integrated file list enumerated with files stored in a plurality of recording media, and controls the combining unit 520 to combine the video signal to be displayed with the created integrated file list.

With reference to FIG. 6, the control unit 510 creates the integrated file list enumerated with files stored in a plurality of recording media (S610), and controls the combining unit 520 to combine a video signal to be displayed with the created integrated file list (S620).

As described above, according to exemplary embodiments of the present invention, the integrated file list integrally providing the list of files dispersedly stored in several recording media can be provided to the user. Consequently, the user can effectively manage the files dispersedly stored in many recording media.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A video appliance comprising:
a combining unit which combines a video signal to be displayed with desired information; and
a control unit which creates an integrated file list enumerated with files stored in a plurality of recording media, and controls the combining unit to combine the video signal to be displayed with the integrated file list.

2. The video appliance of claim 1, wherein one of the plurality of recording media is a recording medium included in the video appliance, and another one of the plurality of recording media is a recording medium included in an external appliance communicably connected to the video appliance.

3. The video appliance of claim 1, wherein the integrated file list enumerates a part or all of the files stored in one of the plurality of recording media and a part or all of the files stored in another one of the plurality of recording media.

4. The video appliance of claim 1, wherein the integrated file list enumerates the files in so that the files are classified and arranged according to file types of the files.

5. The video appliance of claim 4, wherein the file types comprise at least one of a moving image file, a still image file, and a music file.

6. The video appliance of claim 1, further comprising a processing unit which processes a file to reproduce the file;
wherein the control unit applies the file, which is among the files enumerated in the integrated file list, to the processing unit.

7. The video appliance of claim 6, wherein the file is selected by a user.

8. A method of providing an integrated file list, the method comprising:
creating the integrated file list enumerated with files stored in a plurality of recording media; and
combining a video signal to be displayed with the created integrated file list.

9. The method of claim 8, wherein one of the plurality of recording media is a recording medium included in a video appliance, and another one of the plurality of recording media is a recording medium included in an external appliance communicably connected to the video appliance.

10. The method of claim 8, wherein the integrated file list enumerates a part or all of the files stored in one of the plurality of recording media and a part or all of the files stored in another one of the plurality of recording media.

11. The method of claim 8, wherein the integrated file list enumerates the files in so that the files are classified and arranged according to file types of the files.

12. The video appliance of claim 11, wherein the file types comprise at least one of a moving image file, a still image file, and a music file.
